(19) United States
(12) Patent Application Publication
(10) Pub. No.: US 2024/0346916 A1
(43) Pub. Date: Oct. 17, 2024

(54) Bracelet Device and System for Alerting a Wearer of the Device

(71) Applicant: Amber Lee Jaime, Fort Myers, FL (US)

(72) Inventor: Amber Lee Jaime, Fort Myers, FL (US)

(21) Appl. No.: 18/444,900

(22) Filed: Feb. 19, 2024

Related U.S. Application Data
(60) Provisional application No. 63/495,332, filed on Apr. 11, 2023.

(51) Int. Cl. G08B 27/00; G08B 5/38; G08B 6/00; H04W 4/90

(52) U.S. Cl. CPC G08B 27/006; G08B 5/38; G08B 6/00; H04W 4/90

(57) ABSTRACT

A wearable device relating to a lockdown, broadcast alert, or emergency situation alert system designed to provide timely notifications to children and adults with disabilities, particularly those with hearing disabilities, in public locations such as schools, retail stores, and crowded places. The system comprises a novel Bluetooth-compatible bracelet device that can be worn on the wrist and includes an LED for visual illumination and a vibration sensor for providing vibrations to alert the wearer during lockdowns or emergencies. The bracelet device is paired with public announcement devices and handheld user or paired devices enabling centralized control and efficient communication. In response to initiated alerts, the bracelet device illuminates in various colors and generates vibrations, ensuring immediate awareness for individuals. Moreover, the system enables peer communication with nearby user devices for additional alerts.

### CROSS-REFERENCE TO RELATED APPLICATION

The present application claims priority to, and the benefit of, U.S. Provisional Application No. 63/495,332, which was filed on Apr. 11, 2023, and is incorporated herein by reference in its entirety.

### FIELD OF THE INVENTION

The present invention relates generally to the field of safety wearable devices. More specifically, the present invention relates to a novel bracelet device that alerts children and adults with disabilities if there is a lockdown drill, emergency situation, or similar situation at public locations. The device is comprised of a Bluetooth compatible bracelet that will light up and vibrate in a situation where there is a lockdown. The bracelet is constructed using flexible plastic and is equipped with a Bluetooth connection to connect to public announcement devices and other user devices. The bracelet can illuminate in several colors upon activation, simultaneously vibrating and ensuring the wearer is aware of an emergency and/or lockdown. Accordingly, the present disclosure makes specific reference thereto. Nonetheless, it is to be appreciated that aspects of the present invention are also equally applicable to others like applications, devices, and methods of manufacture.

### BACKGROUND

By way of background, many individuals have sensory impairments especially hearing and visual impairments. Due to their sensory impairments, such individuals may not be able to perceive alerts and alarms, making them unaware of nearby emergencies like shootings or other dangerous events. As a result, they often rely on others to inform them about any problems or emergencies that may arise. For children with such disabilities, achieving independence may be more difficult. Such children may need to be constantly accompanied by a friend or teacher to ensure someone is available to notify them in case of an emergency. However, even with constant support of family and friends, such individuals are vulnerable during emergencies.

Another significant issue commonly faced is the exclusion of such individuals from collective and emergency evacuation plans. Traditional evacuation plans often assume that everyone can hear and see emergency alerts, which leaves those with hearing and/or visual impairments at a disadvantage. In situations such as an open or active shooting, impaired individuals are most vulnerable for injuries due to lack of means of instant alerts provided to them. Rescue operations and broadcast alerts are also hard to reach for such individuals due to lack of communication. Individuals desire a device that can instantly notify individuals with hearing and/or visual disabilities about emergencies without requiring physical proximity of teachers, family, friends, and more.

Therefore, there exists a long felt need in the art for a device that can provide instant alerts about an emergency. There is also a long felt need in the art for a wearable device that can provide visual and tactile alerts about an emergency or other similar situation. Additionally, there is a long felt need in the art of a wearable bracelet device that enables the wearer to physically identify the emergency using LED and vibrations. Moreover, there is a long felt need in the art for a wearable device that alerts individuals with disabilities about a lockdown drill, emergency, and other similar situations. Further, there is a long felt need in the art for a bracelet device that receives emergency notifications from public announcement devices and other paired devices. Furthermore, there is a long felt need in the art of a bracelet device that illuminates in several colors upon activation, simultaneously vibrating to make aware the wearer of an emergency and similar situation. Finally, there is a long felt need in the art for a wearable device that keeps hearing and visual impaired individuals safe while they maintain their independence in public spaces.

The subject matter disclosed and claimed herein, in one embodiment thereof, comprises a wearable Bluetooth-enabled bracelet device for providing emergency alerts and assistance to a wearer of the device. The bracelet device is a flexible wrist-worn bracelet and includes an LED light integrated into the bracelet and capable of illuminating in multiple colors for providing visual alerts to catch the wearer's attention during emergencies, with different colors indicating various types of emergencies, a vibration sensor to provide tactile feedback to the wearer, a Bluetooth module for enabling the bracelet to pair with public announcement devices and handheld user devices, and a processor to receive alert signals from the public announcement devices and handheld user devices via Bluetooth, and providing instruction signals to the LED for visual alerts and the vibration sensor for tactile alerts. The device can transmit emergency beacon signals when the wearer remains in an emergency for a threshold period of time.

In this manner, the emergency notification providing bracelet device of the present invention accomplishes all of the forgoing objectives and provides users with a flexible bracelet with an integrated LED light and vibration mechanism that work in conjunction to notify the wearer of an emergency. The device receives notifications from public announcement devices and other paired devices for providing illumination and vibration to the wearer. The device enables impaired individuals to be notified instantly without requiring physical help from other users enabling them to maintain their independence in public spaces.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wearable bracelet device for providing emergency alerts and assistance. The bracelet device further comprising a flexible wrist-worn bracelet, an LED light integrated into the bracelet and capable of illuminating in multiple colors, providing visual alerts to catch the wearer's attention during emergencies, with different colors indicating various types of emergencies, a vibration sensor to provide tactile feedback to the wearer, a Bluetooth module for enabling the bracelet to pair with public announcement devices and handheld user devices, and a processor to receive alert signals from the public announcement devices and handheld user devices via Bluetooth, and providing instruction signals to the LED for visual alerts and the vibration sensor for tactile alerts.

In yet another embodiment, the bracelet device includes an integrated rechargeable battery for providing power to the bracelet device, and a SOS button for enabling the wearer to contact instantly with emergency services or preconfigured contacts.

In another aspect of the present invention, a lockdown, broadcast alert, or emergency situation alert system for providing timely notifications to children and adults with disabilities is disclosed. The system includes a Bluetooth-compatible bracelet device designed to be worn on the wrist, the bracelet has a LED for visual illumination and a vibration sensor for providing vibrations for alerting the wearer in the event of a lockdown, broadcast alert, or emergency situation, one or more public announcement devices, the bracelet device receives emergency notifications from the public announcement devices via a wireless communication channel and processor of the bracelet processes the emergency notifications for generating visual illumination and vibrations.

In yet another aspect of the present invention, the bracelet device illuminates the LED in a first color in a first type of emergency situation and illuminates the LED in a second color in a second type of emergency situation, wherein the first color is different from the second color.

In yet another aspect of the present invention, the bracelet device vibrates in a first pattern in a first type of emergency situation and vibrates in a second pattern in a second type of emergency situation, wherein the first pattern is different from the second pattern.

In yet another embodiment, a method for providing lockdown, broadcast alert, or emergency situation alerts to individuals with disabilities in public locations is described. The method comprising the steps of wearing a Bluetooth-compatible bracelet device on the wrist by children and adults with disabilities, the bracelet device is designed to provide alerts through a combination of visual illumination and vibrations in the event of a lockdown, broadcast alert, or emergency situation, pairing the bracelet device with one or more public announcement devices and handheld user devices to enable communication between the bracelet device and the devices, initiating one or more lockdown, broadcast alert, or emergency alerts from a centrally controlled public announcement device, the public announcement device is capable of transmitting alert signals via a wireless communication channel, receiving the alert signals transmitted via the wireless communication channel by the bracelet device, wherein upon receipt, the bracelet device illuminates in different colors and generates vibrations to alert the wearer of the lockdown, broadcast alert, or emergency situation.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of a lockdown, broadcast alert, or emergency situation alert system of the present invention for disabled individuals in accordance with the disclosed structure;

FIG. 2 illustrates a perspective view of the bracelet device of the present invention in accordance with the disclosed structure;

FIG. 3 illustrates a flow chart depicting a process of providing visual and tactile alert to a wearer by the wearable emergency notification device of the present invention in accordance with the disclosed structure;

FIG. 4 illustrates a flow chart depicting a process of sending an emergency beacon by the bracelet device of the present invention in accordance with the disclosed structure; and

FIG. 5 illustrates a schematic diagram depicting communication between two bracelet devices of the present invention for communicating emergency alert in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a device that can provide instant alerts about an emergency. There is also a long felt need in the art for a wearable device that can provide visual and tactile alerts about an emergency or other similar situation. Additionally, there is a long felt need in the art of a wearable bracelet device that enables the wearer to physically identify the emergency using LED and vibrations. Moreover, there is a long felt need in the art for a wearable device that alerts individuals with disabilities about a lockdown drill, emergency, and other similar situations. Further, there is a long felt need in the art for a bracelet device that receives emergency notifications from public announcement devices and other paired devices. Furthermore, there is a long felt need in the art of a bracelet device that illuminates in several colors upon activation, simultaneously vibrating to make aware the wearer of an emergency and similar situation. Finally, there is a long felt need in the art for a wearable device that keeps hearing and visual impaired individuals safe while they maintain their independence in public spaces.

The present invention, in one exemplary embodiment, is an emergency alert system for providing timely notifications to children and adults with hearing and visual disabilities is disclosed. The system includes a Bluetooth-compatible flexible bracelet designed to be worn on the wrist, the bracelet has a LED for visual illumination and a vibration sensor for providing vibrations for alerting the wearer in the event of a lockdown, broadcast alert, or emergency situation, one or more public announcement devices, the bracelet device receives emergency notifications from the public announcement devices via a wireless communication channel and processor of the bracelet processes the emergency notifications for generating visual illumination and vibrations.

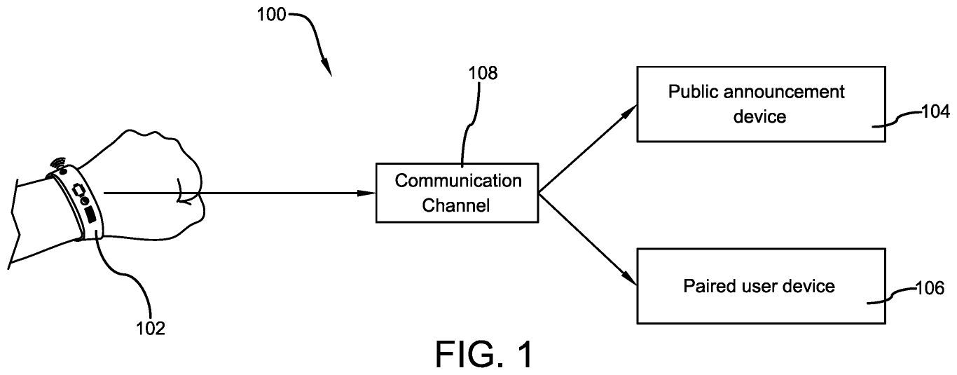

Referring initially to the drawings, FIG. 1 illustrates a schematic diagram of the lockdown, broadcast alert, or emergency situation alert system of the present invention for disabled individuals in accordance with the disclosed structure. The lockdown, broadcast alert, or emergency situation alert system 100 of the present invention is designed to provide alert and notification to children and adults with disabilities such as hearing disability in the event of a lockdown, broadcast alert, or emergency situation in public locations such as schools, retail stores, and other crowded places. The system 100 includes a novel Bluetooth-compatible bracelet device 102 configured to be worn on the wrist. The bracelet 102 is designed to alert the wearer through a combination of lighting up and vibrating in case of a lockdown, emergency situation, and the like.

More specifically, for functionality of the system 100, the bracelet device 102 works in conjunction with one or more public announcement devices 104. The bracelet device 102 can also be paired via a transceiver with handheld user devices 106 such as a smartphone. In use, when there is a lockdown drill or a real emergency situation at a location, the appropriate authorities or personnel can initiate one or more broadcast alerts from the centrally controlled public announcement device 104. The public announcement device 104 can also be in the form of a device equipped with a mobile application. The alert signals are transmitted via the wireless communication channel 108 which is preferably Bluetooth but can also be any other short range communication channel. Upon receiving the alert signals, the bracelet device 102 illuminates in different colors and vibrates to alert the wearer of the lockdown, broadcast alert, or emergency situation.

The bracelet device 102 also enables peer communication with nearby, or within a predetermined distance, paired user device(s) 106 for enabling one or more alert signals to be received from the user device 106. This enables a user such as a teacher, parent, retail store manager and the like to send alert signals to the nearby bracelet devices 106, for example, within a predetermined radius. It will be apparent to a person skilled in the art that the bracelet device 102 can be preconfigured and paired to communicate with the public announcement devices 104 and can be used for regulatory and safety purposes by the authorities.

The bracelet device 102 is especially useful for individuals with hearing and visual disabilities as the combined visual and tactile alerts from the bracelet 102 ensure that the wearer becomes aware of the lockdown, broadcast alert, or emergency immediately and further, the system 100 enables an automatic and central broadcast of the alert signals.

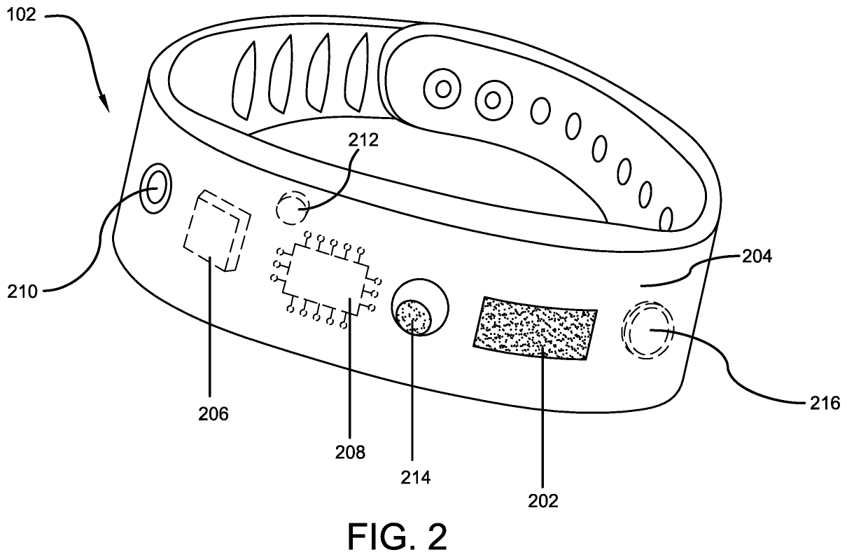

FIG. 2 illustrates a perspective view of the bracelet device of the present invention in accordance with the disclosed structure. The bracelet device 102 is flexible and is designed to be worn around the wrist of a user. The bracelet 102 can be in the form of a closed loop or can have a clasp for securing around the wrist. Further, the bracelet device 102 can be made of plastic, metal, glass, and any other durable and weatherproof material.

More specifically, the bracelet device 102 includes a LED light 202 which can illuminate in multiple colors. The illumination provides a visual alert to catch the wearer's attention and, in some embodiments, different colors may indicate different types of emergencies, providing an additional level of information to the wearer. The LED illumination is visible from the top surface 204 of the bracelet device 102 and can illuminate continuously or flash in other patterns.

A vibration sensor/motor 206 is embedded in the bracelet device 102 for providing tactile feedback to the wearer. Preferably, a vibration motor which can be in the form of eccentric rotating mass motor or linear vibration motor and is used for providing tactile feedback. The motor 206 receives an instruction signal from the processor 208 of the bracelet device 102 for providing vibration. In some embodiments, piezoelectric actuator is used for providing tactile feedback to the wearer.

A wireless transceiver or Bluetooth module 210 is used for pairing the bracelet device 102 with the public announcement device 104 and handheld user device 106. The wireless transceiver 210 establishes the wireless communication channel 108 for functionality and control of the bracelet device 102. The processor 208 is configured to receive an alert signal via the Bluetooth channel 108 and provide an instruction signal to both the LED 202 and the vibration sensor/motor 206 for providing visual alert and tactile alert respectively. The processor 208 is configured to process the incoming alert signal from the devices 104, 106 for providing instructions for illumination in different colors and different pattern of vibrations by the vibration sensor/motor 206.

For providing electric power for working of the bracelet device 102, an integrated battery 212 in the form of a button battery or any other battery known in the state of the art is used in the device 102. The battery 212 is rechargeable and can be wirelessly recharged using a wireless charger and can also be replaced with a new battery. The device 102 includes a SOS button 214 which can be activated by the wearer of the bracelet 102 for contacting 911 service or any preconfigured contact, and/or emit an audible alarm. The SOS button 214 provides an instant help means for the wearer and can protect the wearer in case of any emergency situation.

In the preferred embodiment of the present invention, the bracelet device 102 automatically pairs up with the nearest public announcement device and it can be done using automatic Bluetooth pairing. Alternatively, the bracelet device 102 broadcast GPS location detected using the GPS sensor 216 for effective pairing and receiving alert signals from the nearest announcement device.

All the electronic components described above are sealed and include a waterproof coating applied to a circuit board on which one or more electronic components are fabricated. The bracelet device 102 can be designed to meet a specific IP rating, such as IP67 or IP68, which indicates the level of protection against solid particles such as dust and water.

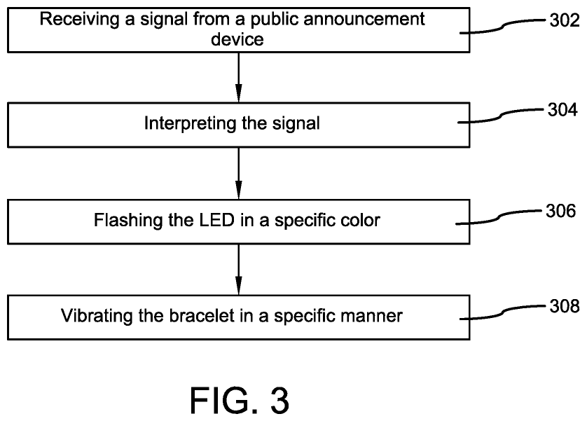

FIG. 3 illustrates a flow chart depicting a process of providing visual and tactile alert to a wearer by the wearable emergency notification device of the present invention in accordance with the disclosed structure. Initially, a signal encoded with an instruction or alert is received by the bracelet device 102 from a public announcement device (Step 302). The public announcement device can be installed by the authorities or 3^{rd} parties at different locations in schools, colleges, retail stores, and other indoor and outdoor areas. After receiving the alert signal, in the next step 304, the processor 208 of the device 102 interprets the signal and determines the type of situation such as a lockdown, shooting, or any other emergency situation.

Then, an instruction signal is transmitted to the LED 202 and the LED 202 illuminates in a specific color to alert the wearer of the device 102 (Step 306). Finally, the vibration sensor/motor 206 provides a tactile feedback or vibration sensation to the wearer for alerting the wearer (Step 308). Duration of the tactile feedback overlaps either partially or completely with illumination of the LED 202.

In one embodiment of the present invention, the LED 202 may flash in Red color when the processor 208 detects an emergency and the vibration sensor/motor 206 vibrates at 150 Hz. In case of a lockdown, the LED 202 may flash in Yellow color and the vibration sensor/motor 206 may vibrate at 120 Hz. Also, the LED 202 may flash in Green color once the lockdown, broadcast alert, or emergency situation is resolved. The type of situation is determined by the processor 208 upon interpreting the alert signal received from one or more devices 104, 106 as illustrated in FIG. 1.

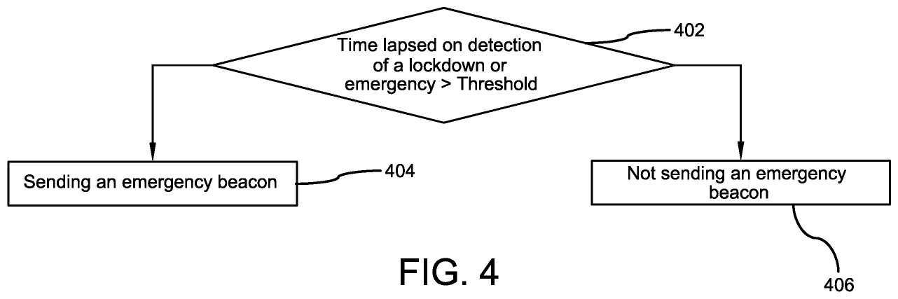

FIG. 4 illustrates a flow chart depicting a process of sending an emergency beacon by the bracelet device 102 of the present invention in accordance with the disclosed structure. Initially, time lapsed after detection of a lockdown, broadcast alert, or emergency situation is measured by the processor 208 of the device 102 and is compared in real-time to a preconfigured threshold time limit (Step 402). The time limit can be 1 minute, 2 minutes, and more and can depend on the type of situation detected by the processor 208.

In case the time lapsed passes the threshold value, then, an emergency beacon signal is automatically sent by the bracelet device 102 to teachers, rescue teams, and more (Step 404). This enables immediate help to be provided to the wearer of the device 102. In case, the time lapsed is smaller than the threshold, then, the emergency beacon is not sent by the bracelet device 102 (Step 406).

In some embodiments, the bracelet device 102 can have one or more biometric sensors to measure vital signs of the wearer during a detected emergency situation and generates the emergency beacon signal upon detecting abnormal vital signs.

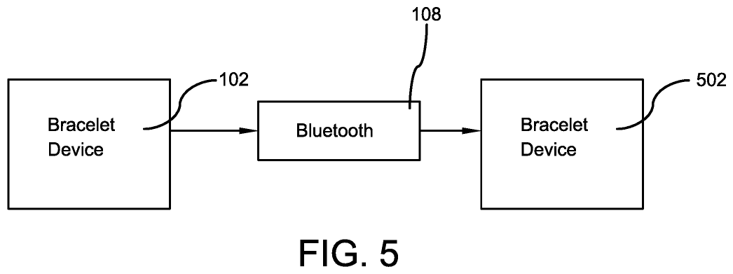

FIG. 5 illustrates a schematic diagram depicting communication between two bracelet devices of the present invention for communicating emergency alert in accordance with the disclosed structure. In the present embodiment, the bracelet device 102 can communicate with other bracelet devices (referred by numeral 502) in the Bluetooth range for enabling the bracelet device 102 to receive alert signals from the other bracelet device 502. This enables the system 100 to alert users who are not in communication range with a public announcement device but are in range with other bracelet devices.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “lockdown, broadcast alert, or emergency situation alert system”, “alert system”, and “system” are interchangeable and refer to the lockdown, broadcast alert, or emergency alert system 100 of the present invention. Similarly, as used herein “novel Bluetooth-compatible bracelet device”, “bracelet device”, and “device” are interchangeable and refer to the alarming wearable bracelet device 102 of the present invention.

Notwithstanding the forgoing, the lockdown, broadcast alert, or emergency alert system 100 and the alarming wearable bracelet device 102 of the present invention can be of any suitable size and configuration as is known in the art without affecting the overall concept of the invention, provided that it accomplishes the above stated objectives. One of ordinary skill in the art will appreciate that the lockdown, broadcast alert, or emergency alert system 100 and the alarming wearable bracelet device 102 as shown in the FIGS. 1-2 are for illustrative purposes only, and that many other sizes and shapes of the lockdown, broadcast alert, or emergency alert system 100 and the alarming wearable bracelet device 102 are well within the scope of the present disclosure. Although the dimensions of the lockdown, broadcast alert, or emergency alert system 100 and the alarming wearable bracelet device 102 are important design parameters for user convenience, the lockdown, broadcast alert, or emergency alert system 100 and the alarming wearable bracelet device 102 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wearable bracelet for alerting the wearer of emergencies, the wearable bracelet comprising:
a combination of a plurality of lights, a vibrator and a transceiver for receiving a public announcement, wherein said public announcement is a broadcast alert;
wherein said bracelet receiving said broadcast alert and actuating said plurality of lights and said vibrator for alerting the wearer of said bracelet of said broadcast alert; and
further wherein said actuating said lights including illuminating said plurality of lights in at least one color.

2. The wearable bracelet for alerting the wearer of claim 1, wherein said broadcast alert is transmitted via a wireless short range communication channel.

3. The wearable bracelet for alerting the wearer of claim 2 further comprising a paired user device, wherein said broadcast alert is transmitted via said paired user device.

4. The wearable bracelet for alerting the wearer of claim 3, wherein said broadcast alert from said paired user device is within a predetermined radius from said paired user device.

5. The wearable bracelet for alerting the wearer of claim 4, wherein said paired user device is a smartphone.

6. The wearable bracelet for alerting the wearer of claim 2, wherein said actuating of said plurality of lights including actuating a first color for a first emergency and at least a second color for a second emergency.

7. The wearable bracelet for alerting the wearer of claim 6, wherein said actuating of said plurality of lights including flashing of at least one light of said plurality of lights.

8. The wearable bracelet for alerting the wearer of claim 2, wherein said vibrator having a motor selected from a group consisting of an eccentric rotating mass motor, a linear vibration motor, and a piezoelectric actuator.

9. A wearable bracelet for alerting the wearer of emergencies, the wearable bracelet comprising:
a plurality of lights, a vibrator, a transceiver and a paired user device for receiving a public announcement, wherein said public announcement is a broadcast alert;
wherein said bracelet receiving said broadcast alert and actuating said plurality of lights and said vibrator for alerting the wearer of said bracelet of said broadcast alert;
wherein said broadcast alert is transmitted via said paired user device; and
further wherein said broadcast alert from said paired user device is within a predetermined radius from said paired user device.

10. The wearable bracelet for alerting the wearer of claim 9, wherein said broadcast alert is transmitted via a wireless short range communication channel.

11. The wearable bracelet for alerting the wearer of claim 10, wherein said actuating said lights including illuminating said plurality of lights in at least one color.

12. The wearable bracelet for alerting the wearer of claim 11, wherein said paired user device is a smartphone.

13. The wearable bracelet for alerting the wearer of claim 12, wherein said actuating of said plurality of lights including actuating a first color for a first emergency and at least a second color for a second emergency.

14. The wearable bracelet for alerting the wearer of claim 13, wherein said actuating of said plurality of lights including flashing of at least one light of said plurality of lights.

15. The wearable bracelet for alerting the wearer of claim 14, wherein said vibrator having a motor selected from a group consisting of an eccentric rotating mass motor, a linear vibration motor, and a piezoelectric actuator.

16. A wearable bracelet for receiving and sending alerts, the wearable bracelet comprising:
a combination of a plurality of lights, a vibrator, a transceiver, a GPS, a SOS signal and a paired user device;
wherein said bracelet receiving a broadcast alert from said paired user device;
wherein said bracelet actuating said plurality of lights and said vibrator for alerting the wearer of said bracelet of said broadcast alert;
wherein said broadcast alert is transmitted via said paired user device; and
further wherein said bracelet sending said SOS signal and said GPS signal to said paired user device for determining a position of the wearer of said wearable bracelet.

17. The wearable bracelet for receiving and sending alerts of claim 16, wherein said SOS signal is an audible alarm.

18. The wearable bracelet for receiving and sending alerts of claim 17, wherein said broadcast alert from said paired user device is within a predetermined radius from said paired user device.

19. The wearable bracelet for receiving and sending alerts of claim 18, wherein said paired user device is a smartphone.

20. The wearable bracelet for receiving and sending alerts of claim 19 further comprising a biometric sensor to measure a vital sign of the wearer of said wearable bracelet, wherein said SOS signal sent to said paired user device upon detection of an abnormal said vital sign.
